(19) United States
(12) Patent Application Publication
(10) Pub. No.: US 2024/0115458 A1
(43) Pub. Date: Apr. 11, 2024

(54) Coupling Apparatus

(71) Applicant: Defibtech, LLC, Guilford, CT (US)

(72) Inventor: Wayne A. Siebrecht, Golden, CO (US)

(21) Appl. No.: 18/459,813

(22) Filed: Sep. 1, 2023

Related U.S. Application Data
(60) Provisional application No. 63/378,495, filed on Oct. 5, 2022.

(51) Int. Cl. A61H 31/00

(52) U.S. Cl. CPC A61H 31/008; A61H 31/007; A61H 2201/0107

(57) ABSTRACT

The invention provides, in some aspects, a coupler for inline connection of two bodies where one of the bodies provides linear motion to the other. Further aspects of the invention provide such a coupler comprising a first adapter linearly engaging a second adapter in a capture B. The first adapter defines a capture C for temporarily securing a first compatible body, and the second adapter defines a connector for securing a second compatible body. The capture B and the connector are oriented one to the other such that linear movement of the first compatible body translates into linear movement of the second compatible body. The capture B releases the secured compatible body upon pressing together of the first and second adapter. In a particular embodiment, a coupler of the type described above joins a compression module of a mechanical CPR device to a patient interface of that device.

### BACKGROUND OF THE INVENTION

This application claims the benefit of priority of U.S. Patent Application Ser. No. 63/378,495, entitled Coupling Apparatus, filed Oct. 5, 2022, the teachings of which are incorporated herein by reference.

Cardiopulmonary Resuscitation (CPR) is a well-known, first-aid treatment ideally performed on a patient suffering cardiac arrest. CPR is an external heart massage technique that manually preserves blood circulation through a patient's body in an attempt to maintain the body's organs, primarily the brain, until a normal heart rhythm, or blood flow, can be restored.

Performing manual CPR (i.e., CPR compressions given by a person) is strenuous, even using devices that provide a mechanical advantage. Proper CPR requires about 100, 5-cm-deep compressions of the chest per minute, each compression potentially requiring a force upwards of 550 N. Therefore, maintaining high-quality, manual CPR for an extended period, even more than several minutes, can be exhausting. Additionally, a CPR provider must maintain proximity to the patient. Maintaining proximity can be challenging to impossible when the patient on whom the CPR is being performed is being moved, whether being carried on a backboard (e.g., through doorways, down halls or on stairs) or being transported in a vehicle.

Autonomous mechanical CPR (AMCPR) devices, which are well known in the art, can overcome many of the issues associated with providing manual CPR. These AMCPR devices can be associated with a patient and once started do not require human intervention, or even necessitate human proximity, and will continue CPR until depletion of their power source.

AMCPR devices generally comprise an upper portion, sometimes referred to as a support assembly that includes a compression unit (i.e., a device having a control system, power source, and extendable ram) for compressing a patient's chest. The support assembly engages a lower portion, sometimes referred to as a backboard. The support assembly and backboard thereby defining a space into which a patient's torso may be positioned. Some support assemblies are self-supporting, but that need not be the case. Additionally, the space may be fully surrounding the patient's chest or partially surround it.

The compression unit is fixed, permanently or temporarily, in the support assembly in such a manner as to interact with a patient's chest proximate the sternum. Where the compression unit has an extendable, reciprocating ram, the ram is ideally positioned with a line of applied compressive force perpendicular to the chest.

The protocol for providing mechanical CPR has evolved. Early on, mechanical CPR was performed by AMCPR devices compressing the chest from the chest's natural position and then letting the chest naturally return to a position, hopefully proximate the natural position, and then compressing again.

It was then determined that it might be desirable that instead of allowing the chest to naturally return to its natural position, it might be beneficial to pull the chest back to a position proximate but at or below the chest's natural position. Then, it was determined there might be beneficial to not only pull the chest back to its natural position but pulling it above the chest's natural position.

The desire to pull up on the chest required that the AMCPR device's compression unit be affixed to a patient's chest. Formerly, the patient interface of the compression module was a pad like structure that merely distributed the force of the CPR over a suitable surface area above the patient's sternum and was not connected to the chest. The need to pull up on the chest required a patient interface that would interact with the patient's chest, i.e., attach to, and withstand the tensile force needed to actually pull the chest upward.

As a result of this “pulling” requirement, the patient interface became ever larger to assure the strength of the necessary connection to the chest. For AMCPR devices with removeable compression modules, the ever-larger patient interface devices proved problematic. More precisely, for AMCPR devices with removable compression modules, the compression module mounts above, and the compression mechanism passes through a bore in the support assembly. It was either not feasible and/or desirable to increase the bore size to accommodate the ever-larger patient interface devices. Therefore, a coupler had to be made to affix it with patient interface device with the compression module but allow the patient interface device to be decoupled from the compression module to facilitate the removal of the compression module.

The coupler of the present invention facilitates the coupling and uncoupling of the patient interface device from the compression module. In situations where it is desirable to store the coupler in a deployable position on the AMCPR device, an optional capture feature may be added to the coupler to temporarily connect it to the AMCPR.

These and other aspects and advantages of the invention will become apparent from the following detailed description and the accompanying drawings that illustrate by way of example the features of the invention.

### SUMMARY OF THE INVENTION

The foregoing objects are among those attained by the invention, which provides, in some aspects, a coupler for inline connection of two bodies where one of the bodies provides linear motion to the other. In a particular embodiment, the coupler joins a compression module of a mechanical CPR device to a patient interface of that device.

Further aspects of the invention provide a coupler, e.g., of the type described above comprising a first adapter linearly engaging a second adapter in a capture B. The first adapter defines a capture C for temporarily securing a first compatible body, and the second adapter defines a connector for securing a second compatible body. The capture B and the connector are oriented one to the other such that linear movement of the first compatible body translates into linear movement of the second compatible body. The capture B releases the secured compatible body upon pressing together of the first and second adapter.

In related aspects, the invention provides a coupler, e.g., as described above, wherein the capture B has a spring latch mounted in the first adapter and a catch in the second adapter, the catch being a surface of the second adapter that is engaged by the spring latch.

Further related aspects of the invention provide a coupler, e.g., as described above, wherein the capture C has a spring latch and a catch that is a surface of the second adapter, whereby the first compatible body is trapped between the spring latch and the surface.

Yet still further related aspects of the invention provide a coupler, e.g., as described above, wherein the first adapter has a capture A. The capture A comprises a spring latch for temporarily securing the coupler to a third compatible body while the coupler is securing the first compatible body. The third body has a surface that when it engages the spring latch the coupler is released from the third compatible body.

Still yet further related aspects of the invention provide a coupler, e.g., as described above, wherein the connector is a rim, and wherein the second body has a suitably dimensioned groove to accept the rim.

Further related aspects of the invention provide a coupler, e.g., as described above, wherein the first compatible body has a cylindrical portion with a distal end to be inserted into a bore defined by the first adapter.

In a further related aspect, the invention provides a coupler, e.g., as described above, wherein the first compatible body has a rim on the distal end for engaging the coupler C.

In still a further related aspect, the invention provides a coupler, e.g., as described above, wherein the capture B only releases the second compatible body upon relative motion between the first and second adapters.

Yet further related aspects of the invention provide a coupler, e.g., as described above, wherein the secured compatible bodies each have a centerline, and the bodies when secured have a common centerline.

Other related aspects of the invention provide a coupler, e.g., as described above, wherein the first compatible body is a distal end of a ram of a mechanical CPR device.

Yet still other related aspects of the invention provide a coupler, e.g., as described above, wherein the second compatible body is a patient interface device for a mechanical CPR device having a groove to receive the connector.

Still yet other related aspects of the invention provide a coupler, e.g., as described above, wherein the patient interface device includes a structure designed to permit temporary attachment of the patient interface device to a patient's chest.

Yet still other related aspects of the invention provide a coupler, e.g., as described above, wherein the third compatible device is a support assembly of a mechanical CPR device.

Further related aspects of the invention provide a coupler, e.g., as described above, wherein the first and second adapter are round.

In other aspects, the invention provides a mechanical CPR device comprising a support assembly having a compression module and a backboard coupling to the support assembly to define an area for placement of a patient's torso between the compression module and the backboard. The compression module has a ram and a patient interface device, the patient interface device being attached to the ram by a coupler. The coupler includes a first adapter linearly engaging a second adapter in a capture B, the first adapter defining a capture C for temporarily securing a first compatible body and the second adapter defining a connector for securing a second compatible body. The capture B and the connector are oriented one to the other such that linear movement of the first compatible body translates into linear movement of the second compatible body, and the capture B releases the secured compatible body upon pressing together the first and second adapter.

Related aspects of the invention provide a coupler, e.g., as described above, wherein the compression module is only temporarily secured in the support assembly and is only removable therefrom by removing the coupler from the ram.

Further aspects of the invention provide a method for coupling a patient interface device to a mechanical CPR device. The method includes the steps of providing a mechanical CPR device having a reciprocating body; providing a coupler that is compatible to engage and be temporarily secured to the reciprocating body, wherein the coupler has two adapter assemblies and is disengaged by pressing (or squeezing) the two adapters together; attaching a patient interface device to the coupler; and attaching the coupler to the reciprocating body.

Related aspects of the invention provide a method, e.g., as described above, further including the step of securing the coupler to the mechanical CPR device prior to the attachment to the reciprocating device.

Further related aspects of the invention provide a method, e.g., as described above, further including the step of securing the coupler to the mechanical CPR device prior to attachment to the reciprocating device in a position such that the reciprocating device is capable of disconnecting the reciprocating device from the mechanical CPR device.

Yet still further related aspects of the invention provide a method, e.g., as described above, further including the step of decoupling the coupler from the mechanical CPR device by installing the reciprocating device in the mechanical CPR device.

Further aspects of the invention are evident in the description that follows, the drawings and the claims.

### BRIEF DESCRIPTION OF THE DRAWINGS

A more complete understanding of the invention may be attained by reference to the drawings, in which:

FIG. 1 is a top view of a coupling device according to a practice the invention.

FIG. 2A is a side view of the coupling device shown in FIG. 1 taken along line A-A.

FIG. 2B is a side view of the coupling device shown in FIG. 1 taken along line B-B.

FIG. 3 is an exploded auxiliary view of the coupling device shown in FIG. 1.

FIG. 4 is a side view of the first adapter shown in FIG. 2A.

FIG. 5 is a bottom view of the first adapter shown in FIG. 4 taken along line F-F.

FIG. 6 is a top view of the first adapter shown in FIG. 4 taken along line D-D.

FIG. 7 is a side view of the second adapter shown in FIG. 2A.

FIG. 8 is a bottom view of the second adapter shown in FIG. 5 taken along line E-E.

FIG. 9 is a top view of the second adapter shown in FIG. 5 taken along line G-G.

FIG. 10 is a side view of a mechanical chest compression device using the coupling device shown in FIG. 1.

FIG. 11 is a downward looking auxiliary of the mechanical chest compression device shown in FIG. 10 (the coupling device in the view is not seen).

FIG. 12 is a top view of the coupling of FIG. 1 engaged with a chest attachment device.

FIG. 13 is a side view of the coupling of FIG. 1 engaged with a chest attachment device shown in FIG. 12 taken along line H-H as to the coupler.

FIG. 14 is an detailed view of area J shown in FIG. 13.

FIG. 15 is an exploded view of FIG. 10 taken along line K-K, which line is shown in FIG. 16 showing the initial position of the compression module to a support assembly.

FIG. 16 is a side view of the mechanical chest compression device in its initial position.

FIGS. 17 and 17A show the patient attachment assembly with the coupler engaged to the arch assembly of the mechanical chest compression device with the expanded view taken along line H-H, see FIG. 12 as to orientation of the coupler.

FIGS. 18 and 18A show the ram of the compression module engaged in the coupler on device taken along line J-J, see FIG. 12 as to orientation of the coupler.

FIGS. 19 and 19A show the impact sleeve of the compression module engaged with the coupler on device with the taken along line H-H, see FIG. 12 as to orientation of the coupler.

FIGS. 20 and 20A show patient attachment assembly disengaged from the support assembly on the mechanical chest compression device.

FIGS. 21 and 21A depict a side view that shows the position after the compression module is locked in the support assembly s.

FIGS. 22 and 22A depict a side view that shows the chest attachment device in the ready to detach position.

FIG. 23 is a side view that shows the chest attachment device detached from the mechanical chest compression device.

### DETAILED DESCRIPTION OF THE ILLUSTRATED EMBODIMENTS

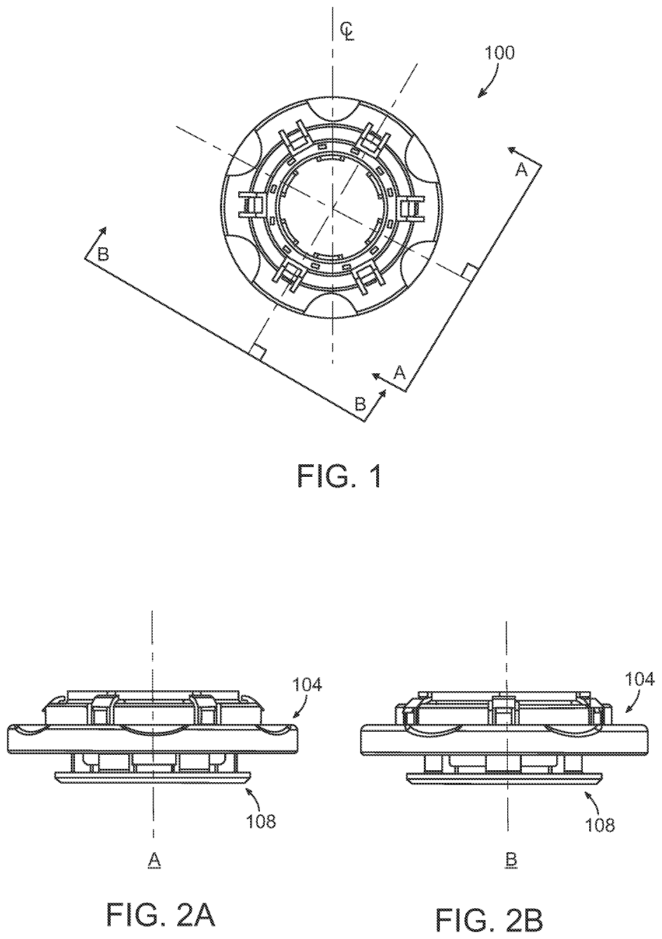

As shown in FIGS. 1 and 2, a coupler (referred to by reference 100) comprises a first adapter 104 and a second adapter 108. As shown, the coupler is circular in shape, but that is not a requirement of the invention. FIG. 2A shows a side view of the coupler taken along the line A-A in FIG. 1, and FIG. 2B is another side view of the coupler taken along the line B-B in FIG. 1. Unless otherwise indicated, side views of the coupler, or components thereof, in subsequent figures are taken from the perspective depicted in FIG. 2A.

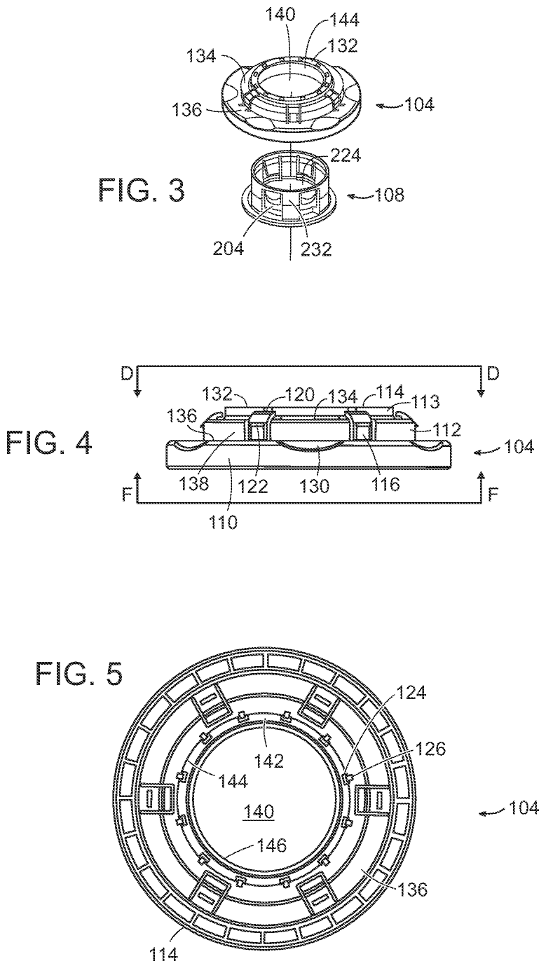

Continuing with FIG. 3, for clarity the first adapter 104 and the second adapter 108 of the coupler 100 are shown in an exploded perspective view.

Continuing with FIGS. 3, 4, 5 and 6, the first adapter has three levels, a first level 110, a second level 112, and a third level 113. These three levels define steps from an exterior outer surface 148 of the first level toward the center of the coupler 100 culminating at the third level's inner surface 144, which defines a bore 140.

Focusing on the first level 110, the first level's exterior upper surface 136 has several depressions 130. The depressions are shaped and sized to interact with the thumbs of a person (not shown). The use of these depressions is discussed below.

Focusing on the first level 110 and the second level 112, there is a connecting exterior middle wall 138. The exterior middle wall has a series of openings for a series of Latches A 116. The Latches A are a portion of a Captures A (referred to by reference number 114) which further includes a Catches A 118. The Captures A joins the upper body 104 to a to be determined compatible body. The Captures A is further discussed below in an illustrative application having an illustrative compatible body.

As illustrated herein, a “capture” is something that secures one thing to another. In this illustrative embodiment a capture includes a hinged latch that interacts with a surface to secure a compatible body. In some cases, this interaction defines a space, or void into which a compatible body is effectively trapped, and in other cases the latch may interact with the other body, such as by snapping into a surface of a void in the other body.

In this embodiment, the Latches A 116 of the first adapter 104 are hinge mounted within the exterior lower surface 136 and shaped to place the appendage A above the exterior lower surface. Thus, in operation, a compatible body upon contacting the Latches A causes the Latches A to deflect inward and upon passing by the appendage A the Latches A returns to is original position trapping the compatible body between the appendage and the Catches A.

This Captures A 114 further allows for decoupling of a compatible body from the coupler 100 by depressing release A 120. Thus, the Captures A can be used when it is desirable to have a non-destructive means of releasing the captured compatible body from the coupler 100. More specifically, releasing the captured compatible body is accomplished by pressing on the Release A, whereby the Latches A 116 will deflect inward causing the appendage A 122 to relocate and release the captured compatible body.

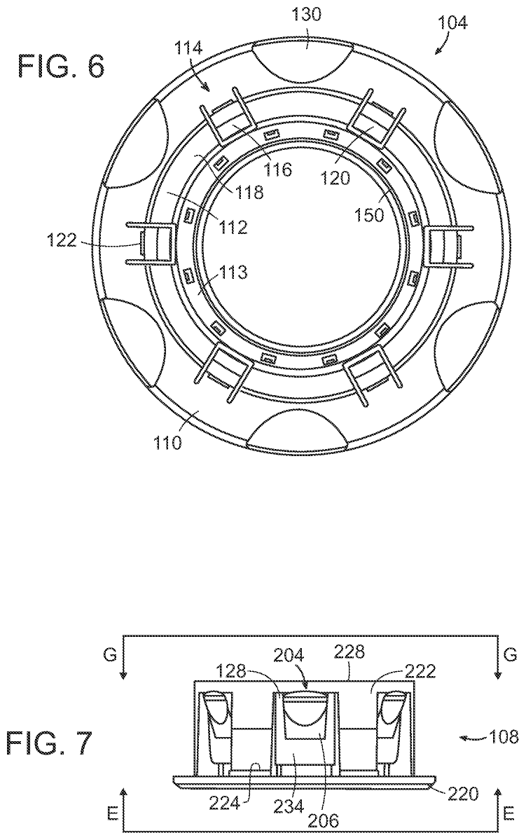

Focusing on the underside of the first adapter 104, FIG. 6, the underside has a Captures B 124. Captures B captures the second adapter 108 in the first adapter 104 in a slot 142, which has an inner surface 150. Captures B includes a Latches B 126 and a Catches B 142. In this Captures B, the Latches B is a spring latch and is designed to deflect outward as the second adapter pass and back into a catch, a void, in the second adapter 108. The interaction of the first adapter and second adapter as to Captures B is further discussed below.

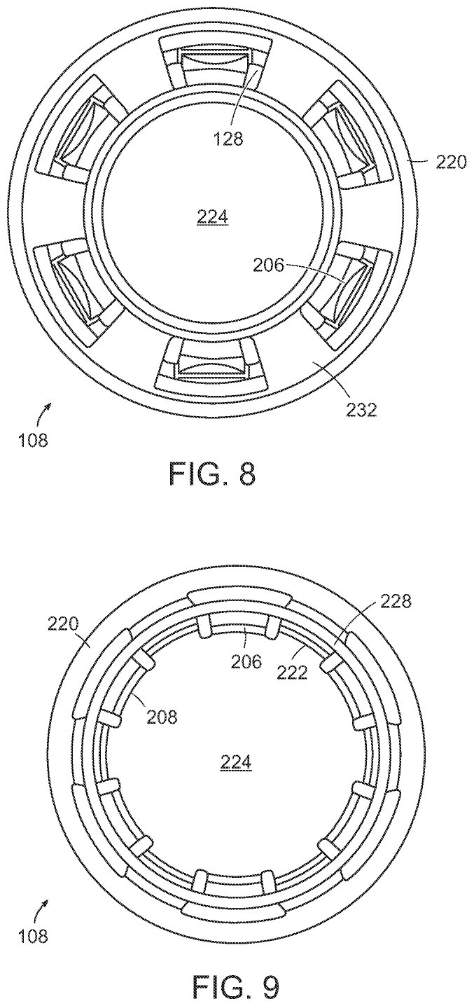

Continuing with FIGS. 7, 8 and 9, the second adapter 108 includes a support 222. Mounted on one end of the support is a connector 220, which is illustrated as a rim. The support on the other end defines an upper surface 222. Mounted within the support parallel with and below the upper surface is a base 224. The illustrated base in flat but that is not a requirement of the invention. More specifically, the based can have alternate contour based on the distal end of a compatible body. The support from the upper surface to the base defines a bore 140. Also, mounted within the support, in a series of slots 234, are Latches C 206, which are a portion of a Captures C 204. Catches C 208 of Captures C is the base. The Latches C are hinged and oriented toward the base with a portion protruding into the bore. The Latches C flex outward as a compatible body inserted in the bore and advances in the body toward the base, until the compatible body passes the Latches C whereafter they spring back; thereby, trapping the compatible body between in the Captures C.

As previously described, the first adapter 104 is mated to the second adapter 108 by Captures B. Referring to FIG. 14, the support 222 of the second adapter is inserted into the slot 142 of the first adapter. As the support pass Latches B, the latches flex outward until the support reaches Catches B 128, which is a surface of a void in which the latches C 206 are positioned, and the Latches B spring outward to engage Catches B.

Captures B may be designed to allow a compatible body captured by Captures C 204 to be released. Referring again to FIG. 14, the slot 142 may be dimensioned to permit linear movement between the two adapters 104, 108. Linear movement between the two adapters 104, 108 is achieved by compressing the adapters together. Upon compression, the inner surface 150 of the slot 142 will engage the Latches C 206 forcing them outward; thereby, letting the previously secured compatible body to pass by the Latches C and thereby to be removed from the coupler 100.

Illustrative Usage of the Coupler

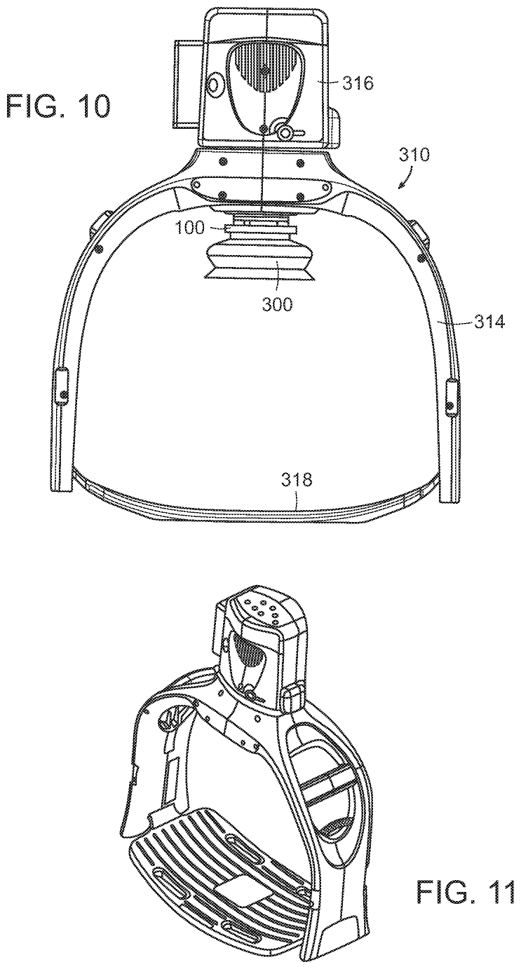

Continuing with FIG. 10, the coupler 100 is used in an illustrative mechanical CPR device 310 to connect the compression module 316 with a patient attachment device 300. The coupler 100 is needed as the compression module is removable for storage and the patient interface device is dimensioned such that it will not pass through the bore 324.

In this mechanical CPR device 310, the compression module 316, which is well known in the art, contains the necessary electronic, computer programming and power source to cause the patient interface to reciprocate thereby providing CPR to a patient to which the patient interface is affixed. The basic components of this type of CPR device are a compression module, support assembly 314 and backboard 318. A typical example of such a CPR device is Defibtech's ARM.

Continuing with FIGS. 13 and 14, the coupler 100 is connected to the patient interface 306. The patient interface defines a groove 302. The groove is dimensioned to accept and retain the connector 220 during operation of the mechanical CPR device.

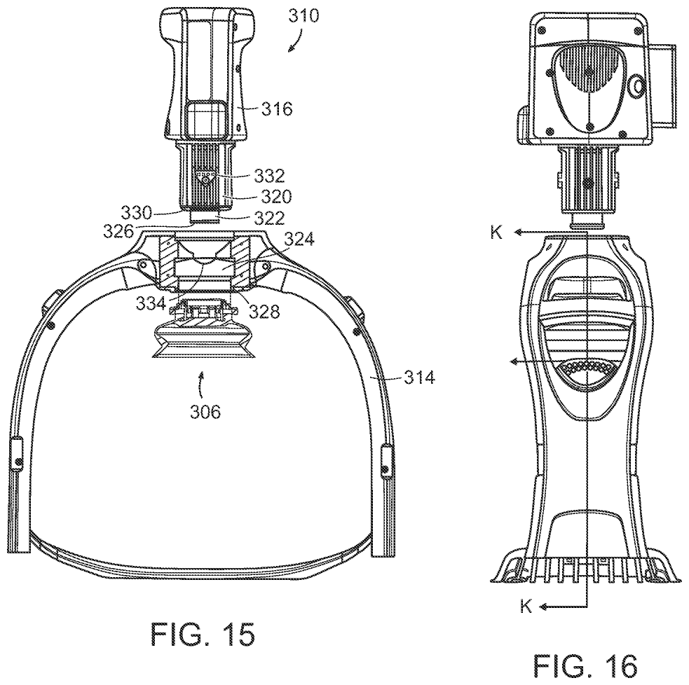

FIGS. 15 and 16 show three basic elements of the mechanical CPR device 310 in a pre-operation configuration. In this mechanical CPR device, the compression module 316 is removable, but that is not a requirement to use the coupler 100. Therefore, for deployment of the mechanical CPR device the coupler 100 affixes the patient interface 300 to the compression module.

Primary components of the compression module 316 relevant to the invention are a ram 322 having a distal end flange 326, inside an inner sleeve 330 which is inside an outer sleeve 330. The compression module is mounted within a bore 324 defined by the support assembly 314 and held in the bore by a coupling system having a cooperating Latches 332 and Catches 334. In this exemplary usage, the coupling is made by having the compression module inserted into the bore such that for operation a 90-degree rotation is required to fully engage the compression module in the support assembly. During coupling, the rotation of the compression module 90 degrees causes the compression module to advance and lock in the bore 324.

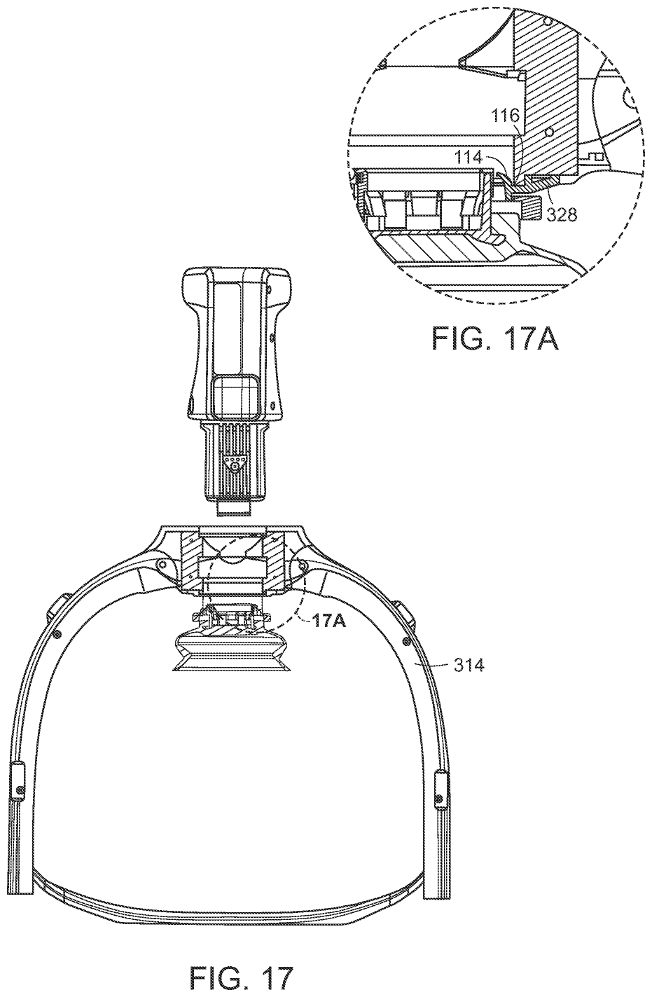

As shown in FIG. 17 and expanded view A, the coupler 100 is designed to connect the coupler to the support assembly 314. As previously discussed, the coupler has a Captures A 114 having a Latches A 116. The support assembly has at the end of the bore a Catches A 328 the forms the other portion of the Captures A. When the coupler is pushed into the Catches A, the Latches A 116 deflects inward as the coupler further advances until the Latches A springs back on the Catches A.

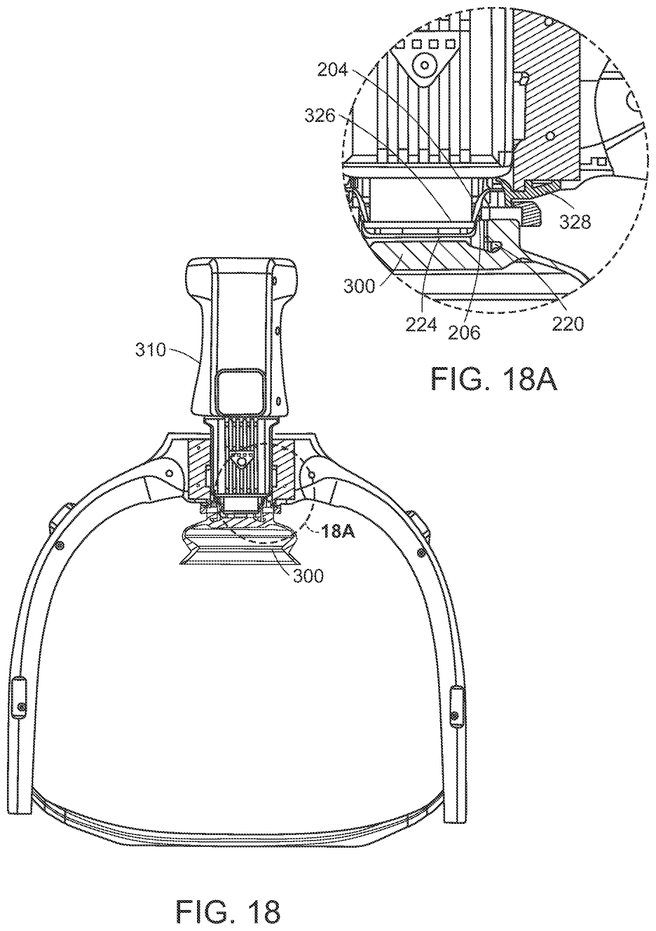

Continuing with FIGS. 18 and 18A, the compression module 134 is advanced in the bore 140 toward the backboard 318 until the ram's distal end flange 326 is engaged in Captures C 204. More specifically, as the distal end flange advances, it contacts the Latches C 206 forcing the Latches to deflect outward. As the distal end flange passes the Latches, the Latches spring back trapping the distal end flanges between the Latches C and the Catches C 208.

It should be noted that the distal end flange 326 when trapped in Catches C 208 is dimensioned to prevent linear movement of the second adapter 108 relative to the first adapter 104 by pushing upward on the second adapter, where the position of the first adapter is not fixed. This connection, however, can be released, which is discussed below.

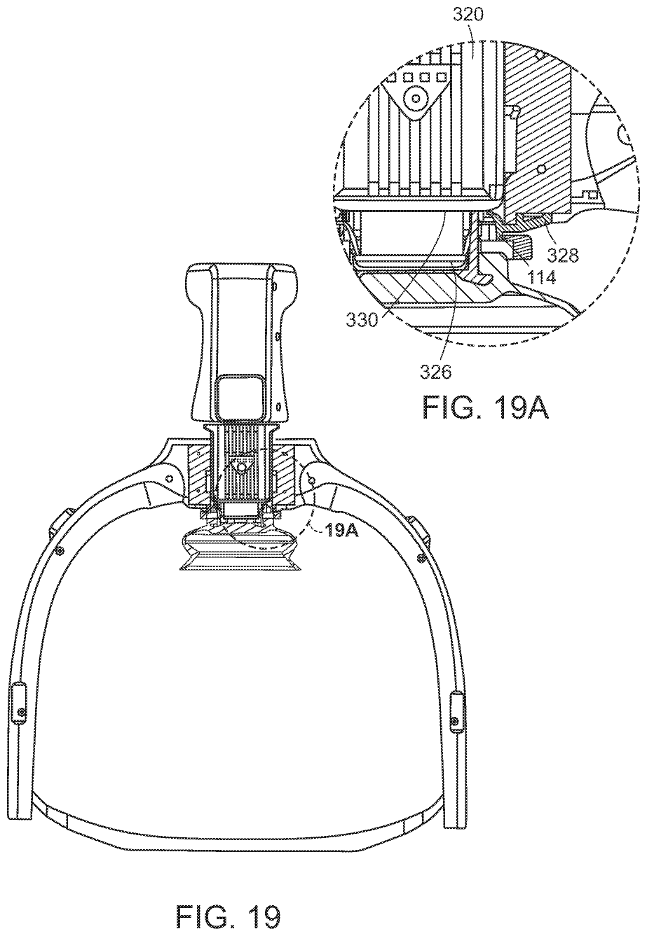

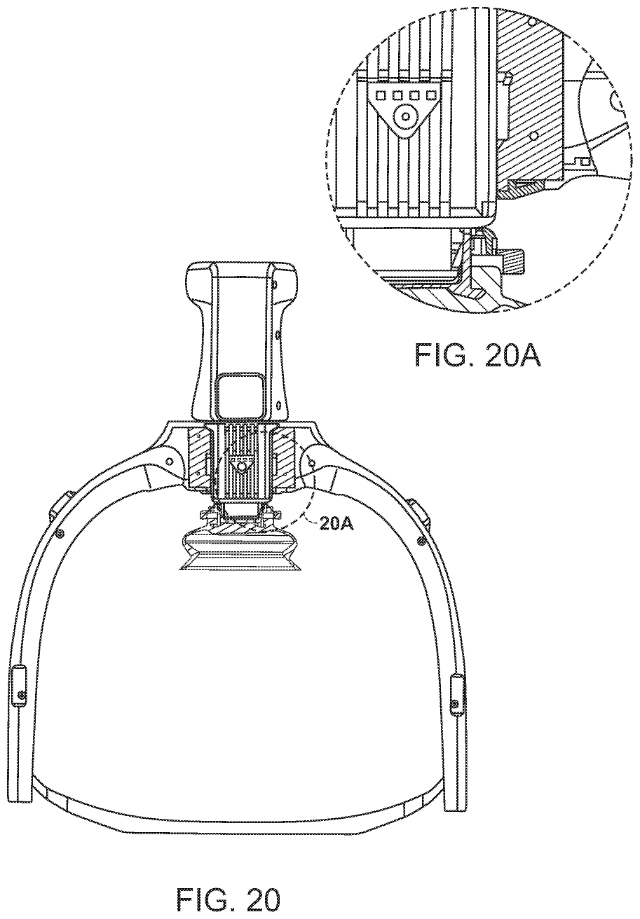

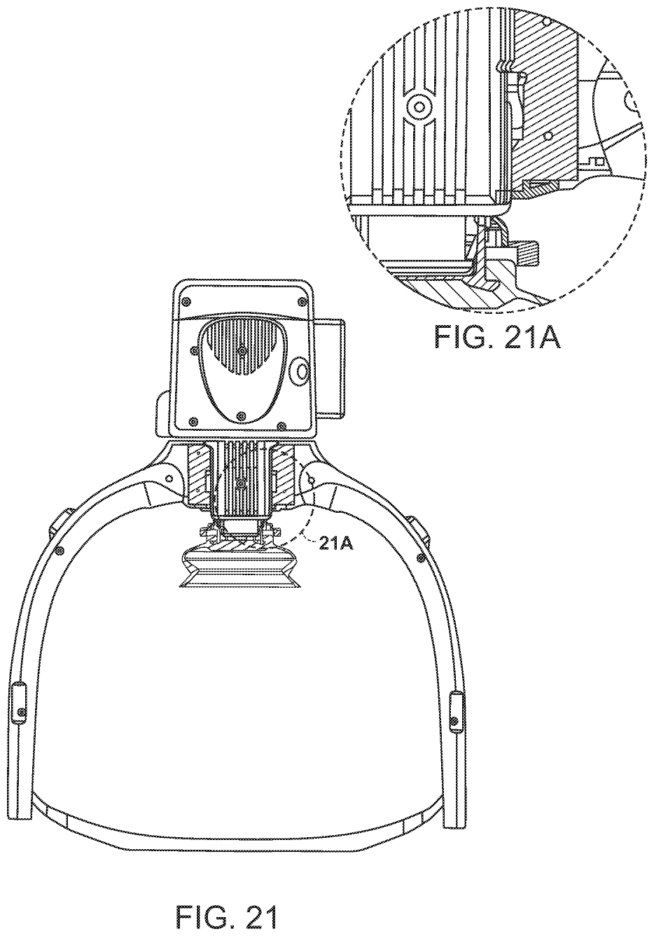

As shown in FIGS. 19 and 19A, as the compression module 134 continues to advance, the inner sleeve 330 contacts the Latches a 116. Further advance of the compression module causes the Latches C to deflect outward thereby disengaging the coupler 100 from the support 222, as shown in FIGS. 20 and 20A. After disengagement of the coupler, as shown in FIGS. 21 and 21A the compression module 316 is rotated 90 degrees into its operational position.

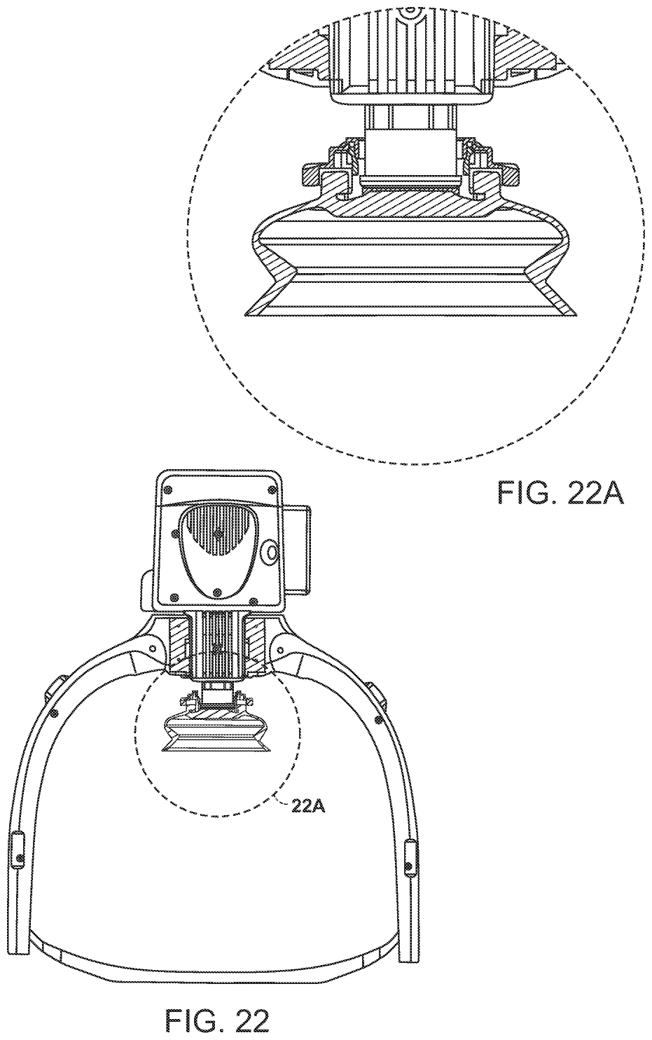

Referring to FIGS. 22 and 22A, after disengagement of the coupler 100 from the support assembly 314, the patient attachment 306 can be positioned for use. Positioning for use means putting the patient attachment is a desired starting location to begin providing therapy.

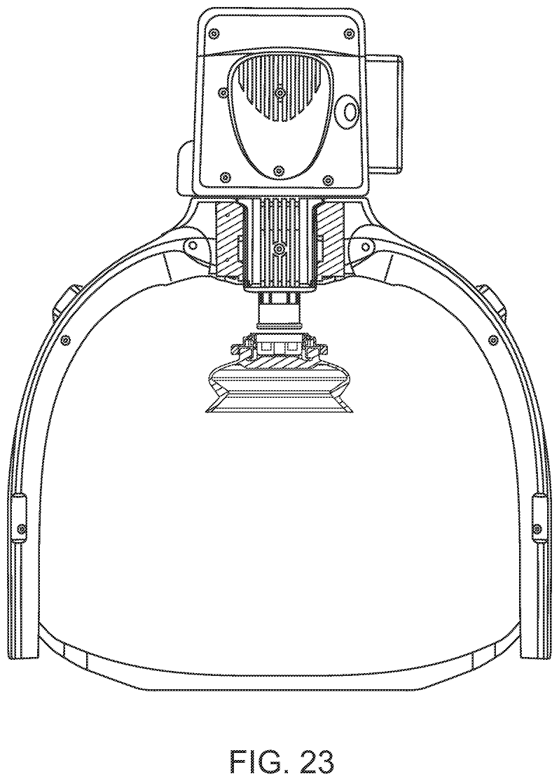

Finally, as shown in FIG. 23, after the patient interface 300 is used to provide therapy, or at any other time, the coupler 100 can be non-destructively disengaged from the ram 322. Disengagement is accomplished by pushing together the first and second adapter, 104 and 108, respectively.

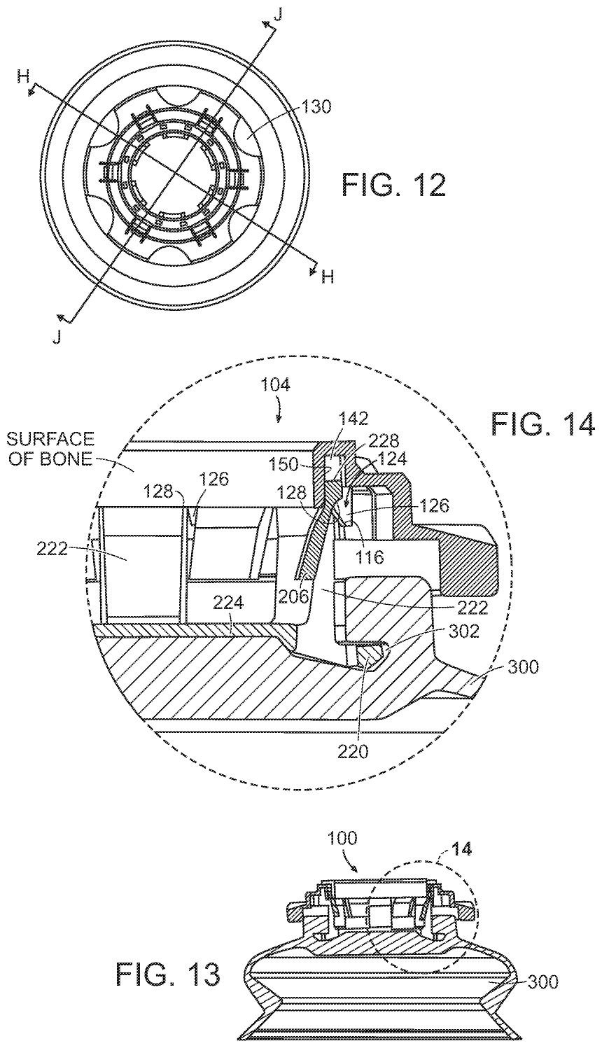

More specifically, as shown in FIG. 14, when the first and second adapter were connected by Captures B 124 there was a slot 142 that after Captures permitted linear movement of the first and second adapters relative to each other. Referring to FIG. 12, by placing one's thumbs in the depressions 130 and fingers under the patient interface 300 and compressing the movement permitted causes the inner flange 146 to contact the Latches B 126 of Captures B 124 to deflect outward release the distal end flange 326 from Captures B, thereby non-destructively releasing the compression module 310 for the coupler 100.

While certain example or illustrative examples have been described, these examples have been presented by way of example only and are not intended to limit the scope of the inventions disclosed herein. Indeed, the novel methods and systems described herein may be embodied in a variety of other forms. The accompanying claims and their equivalents are intended to cover such forms or modifications as would fall within the scope and spirit of certain of the inventions disclosed herein.

1. A coupler comprising:
a first adapter linearly engaging a second adapter in a capture B;
the first adapter defining a capture C for temporarily securing a first compatible body and the second adapter defining a connector for securing a second compatible body;
the capture B and the connector oriented one to the other such that linear movement of the first compatible body translates into linear movement of the second compatible body; and
the capture B releasing the secured compatible body upon pressing together of the first and second adapter.

2. The coupler of claim 1 wherein the capture B has a spring latch mounted in the first adapter and a catch in the second adapter, the catch being a surface of the second adapter that Is engaged by the spring latch.

3. The coupler of claim 1 wherein the capture C has a spring latch and a catch, where the catch is a surface of the second adapter whereby the first compatible body is trapped between the spring latch and the surface.

4. The coupler of claim 1 wherein the first adapter has a capture A, the capture A comprising a spring latch for temporarily securing the coupler to a third compatible body while the coupler is securing the first compatible body and the third body has a surface that when it engages the spring latch the coupler is released from the third compatible body.

5. The coupler of claim 1 wherein the connector is a rim, and the second body has a suitably dimensioned groove to accept the rim.

6. The coupler of claim 1 wherein the first compatible body has a cylindrical portion with distal end to be inserted into a bore defined by the first adapter.

7. The coupler of claim 6 wherein the first compatible body has a rim on the distal end for engaging the coupler C.

8. The coupler of claim 1 wherein the capture B only releases the second compatible body upon relative motion between the first and second adapters.

9. The coupler of claim 1 wherein the secured compatible bodies each having a centerline, and the bodies when secured have a common centerline.

10. The coupler of claim 1 wherein the first compatible body is a distal end of a ram of a mechanical CPR device.

11. The coupler of claim 1 wherein the second compatible body is a patient interface device for a mechanical CPR device having a groove to receive the connector.

12. The coupler of claim 11 wherein the patient interface device includes a structure designed to permit temporary attachment of the patient interface device to a patient's chest.

13. The coupler of claim 1 wherein the third compatible device is a support assembly of mechanical CPR device.

14. The coupler of claim 1 where the first and second adapter are round.

15. A mechanical CPR device comprising:
a support assembly having a compression module;
a backboard coupling to the support assembly to define an area for placement of a patient's torso between the compression module and the backboard;
the compression module having a ram and a patient interface device, the patient interface device attached to the ram by a coupler; and
wherein the coupler includes a first adapter linearly engaging a second adapter in a capture B;
the first adapter defining a capture C for temporarily securing a first compatible body and the second adapter defining a connector for securing a second compatible body; the capture B and the connector oriented one to the other such that linear movement of the first compatible body translates into linear movement of the second compatible body; and the capture B releasing the secured compatible body by pressing together the first and second adapter.

16. The mechanical CPR device of claim 15 wherein the compression module is only temporarily secured in the support assembly and is only removable therefrom by removing the coupler from the ram.

17. A method for coupling a patient interface device to a mechanical CPR device:
providing a mechanical CPR device having a reciprocating body;
providing a coupler, the coupler being compatible to engage and be temporarily secured to the reciprocating body, wherein the coupler has two adapter assemblies and is disengaged by squeezing the two adapter assemblies together;
attaching a patient interface device to the coupler; and
attaching the coupler to the reciprocating body.

18. The method of claim 17 further including the step of securing the coupler to the mechanical CPR device prior to the attachment to the reciprocating device.

19. The method of claim 17 further including the step of securing the coupler to the mechanical CPR device prior to attachment to the reciprocating device in a position such that the reciprocating device is capable of disconnecting the reciprocating device from the mechanical CPR device.

20. The method of claim 19 further including the step of decoupling the coupler from the mechanical CPR device by installing the reciprocating device in the mechanical CPR device.
